(19) United States
(12) Patent Application Publication
(10) Pub. No.: US 2014/0358652 A1
(43) Pub. Date: Dec. 4, 2014

(54) Facilitating Online Transactions

(71) Applicant: Vijay Kanth Dandamudi, Battle Creek, MI (US)

(72) Inventor: Vijay Kanth Dandamudi, Battle Creek, MI (US)

(21) Appl. No.: 13/905,602

(22) Filed: May 30, 2013

(51) Int. Cl. G06Q 30/02

(52) U.S. Cl. CPC G06Q 30/0212
USPC 705/14.14

(57) ABSTRACT

Techniques for operating a marketplace server include receiving a purchase request of a user and a payment corresponding to the purchase request from an account associated with the user. The techniques include allocating a first portion of the payment to a drawing system being comprised of a plurality of available drawings and awarding one or more entries to a user. The user can enter each entry into one of a plurality of available drawings. Each available drawing has a respective prize and having its own respective odds. The techniques also include receiving one or more user submissions, each user submission indicating a selection of one of the plurality of available drawings in which one of the one or more entries is to be entered. The techniques further include entering one of the entries of the user into a selected available drawing indicated in the user submission.

### TECHNICAL FIELD

This disclosure relates to facilitating on-line transactions, such as administering a plurality of drawings for prizes on a marketplace server.

### BACKGROUND

More consumers are turning to on-line shopping to purchase some or all of their goods and services. For example, consumers have turned to on-line stores to purchase clothing, books, music, and movies. The on-line sales model offers very little barriers to entry and is, therefore, ultracompetitive. Therefore, on-line retailers are continuously seeking to improve their respective offerings and to attract new customers.

### SUMMARY

One aspect of the disclosure provides a method. The method includes receiving, at a processing device, a purchase request of a user, the purchase request indicating a good or service to be purchased by the user. The method further includes receiving, at the processing device, a payment corresponding to the purchase request from an account associated with the user and allocating, at the processing device, a first portion of the payment to a drawing system being comprised of a plurality of available drawings. The method also includes awarding, at the processing device, one or more entries to a user. The user can enter each entry into one of a plurality of available drawings. Each available drawing is for a respective prize and has its own respective odds. The method further includes receiving, at the processing device, one or more user submissions, each user submission indicating a selection of one of the plurality of available drawings in which one of the one or more entries is to be entered. The method further includes for each user submission, entering, at the processing device, one of the entries of the user into a selected available drawing indicated in the user submission.

Implementations of the disclosure may include one or more of the following features. In some implementations, the method includes allocating, at the processing device, a second portion of the payment to a seller of the good or service. The purchase request may be for one or more digital media files.

In some implementations, the method includes providing, from the processing device, instructions corresponding to a graphical user interface to a remote computing device. The instructions may be configured to cause the graphical user interface to display the plurality of available drawings and receive the one or more user submissions. Additionally or alternatively, the instructions may be configured to cause the graphical user interface to display odds of winning each available drawing. In some examples, the instructions are configured to cause the graphical user interface to display, for each available drawing, a first amount of entries that have already been entered in the available drawing and a second amount of entries that are to be entered in the available drawing before a winner of the available drawing is selected.

In some implementations, each available drawing has a corresponding upper limit of entries. The upper limit of a respective available drawing defines a total amount of entries that can be entered in the respective available drawing before a winner of the respective available drawing is selected.

In some implementations, the method includes receiving the purchase request from a remote computing device associated with the user. Moreover, the prize may be a cash prize in an amount that is independent of the other available drawings.

Another aspect of the disclosure provides a server that includes a non-transitory storage device, a network interface device, and a processing device executing a transaction module and a drawing module. The transaction module is configured to receive a purchase request of a user, the purchase request indicating a good or service to be purchased by the user, receive a payment corresponding to the purchase request from an account associated with the use, and allocate a first portion of the payment to a drawing system being comprised of a plurality of available drawings. The drawing module is configured to award one or more entries to the user. The user can enter each entry into one of a plurality of available drawings, each available drawing being for a respective prize and having its own respective odds. The drawing module is further configured to receive one or more user submissions, each user submission indicating a selection of one of the plurality of available drawings in which one of the one or more entries is to be entered. For each user submission, the drawing module enters one of the entries of the user into a selected available drawing indicated in the user submission.

In some implementations, the transaction module is further configured to allocate a second portion of the payment to a seller of the good or service. Additionally, the purchase request may be for one or more digital media files.

In some implementations, the drawing module is further configured to provide instructions corresponding to a graphical user interface to a remote computing device. The instructions being configured to cause the graphical user interface to display the plurality of available drawings and receive the one or more user submissions. Additionally or alternatively, the instructions are further configured to cause the graphical user interface to display odds of winning each available drawing. In another example, the instructions are configured to cause the graphical user interface to display, for each available drawing, a first amount of entries that have already been entered in the available drawing and a second amount of entries that are to be entered in the available drawing before a winner of the available drawing is selected.

In some examples, each available drawing has a corresponding upper limit of entries. The upper limit of a respective available drawing defines a total amount of entries that can be entered in the respective available drawing before a winner of the respective available drawing is selected.

In some implementations, the purchase request is received from a remote computing device associated with the user. In some examples, the prize is a cash prize in an amount that is independent of the other available drawings.

Another aspect of the disclosure provides a computer program product encoded on a non-transitory computer readable storage medium comprising instructions that when executed by a data processing apparatus cause the data processing apparatus to perform operations. The operations include receiving a purchase request of a user, the purchase request indicating a good or service to be purchased by the user, receiving a payment corresponding to the purchase request from an account associated with the user, and allocating a first portion of the payment to a drawing system being comprised of a plurality of available drawings. The operations further include awarding one or more entries to a user, wherein the user can enter each entry into one of a plurality of available drawings, each available drawing being for a respective prize and having its own respective odds and receiving one or more user submissions, each user submission indicating a selection of one of the plurality of available drawings in which one of the one or more entries is to be entered. The operations also include, for each user submission, entering one of the entries of the user into a selected available drawing indicated in the user submission.

In some implementations, the operations further include allocating a second portion of the payment to a seller of the good or service. Moreover, the purchase request may be for one or more digital media files.

In some implementations, the operations may include providing instructions corresponding to a graphical user interface to a remote computing device. The instructions may be configured to cause the graphical user interface to display the plurality of available drawings and receive the one or more user submissions. Additionally or alternatively, the instructions may be configured to cause the graphical user interface to display odds of winning each available drawing. Moreover, the instructions may be configured to cause the graphical user interface to display, for each available drawing, a first amount of entries that have already been entered in the available drawing and a second amount of entries that are to be entered in the available drawing before a winner of the available drawing is selected.

In some implementations, each available drawing has a corresponding upper limit of entries. The upper limit of a respective available drawing defines a total amount of entries that can be entered in the respective available drawing before a winner of the respective available drawing is selected. In some implementations, the purchase request is received from a remote computing device associated with the user. In some examples, the prize is a cash prize in an amount that is independent of the other available drawings.

Another aspect of the disclosure provides a method. The method includes receiving, at a processing device, a purchase request for a remote computing device of a user, the purchase request indicating a digital media content to be purchased by the user. The method also includes receiving, at the processing device, authorization to charge the user an amount of indicated in the purchase request from a financial institution associated with the user. The method further includes providing, at the processing device, access to the digital media content to the user in response to the authorization. The method also includes receiving, at the processing device, a payment in the amount authorized by the financial institution from an account of the user at the financial institution. The method also includes allocating, at the processing device, a first portion of the payment to a drawing system being comprised of a plurality of available drawings and allocating, at the processing device, a second portion of the payment to a provider of the digital media content. The method further includes awarding, at the processing device, one or more entries to a user based on a value of the first portion, wherein the user can enter each entry into one of a plurality of available drawings, each available drawing being for a cash prize and having its own respective odds. The method also includes receiving, at the processing device, one or more user submissions, each user submission indicating a selection of one of the plurality of available drawings in which one of the one or more entries is to be entered. The method further includes for each user submission, entering, at the processing device, one of the entries of the user into a selected available drawing indicated in the user submission. For each available drawing, the method also includes determining, at the processing device, whether a drawing condition of the available drawing has been met, and when the drawing condition has been met, determining a winner of the available drawing.

The instructions are configured to cause the graphical user interface to display the plurality of available drawings, odds of winning each available drawing, a first amount of entries that have already been entered in the available drawing, and a second amount of entries that are to be entered in the available drawing before a winner of the available drawing is selected. The instructions may be configured to cause the graphical user interface to receive the user submissions.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view illustrating an example environment of a marketplace server.

FIG. 2 is a swim-lane diagram illustrating an example of a transaction performed using the marketplace server.

FIG. 3 is a schematic view illustrating example components of a marketplace server.

FIG. 4A is a schematic view of an exemplary graphical user interface for purchasing a good from the marketplace server.

FIG. 4B is a schematic view of an exemplary graphical user interface for entering one or more available drawings.

FIG. 5 is a flow chart illustrating an example set of operations for a method for facilitating a transaction.

FIG. 6 is a flow chart illustrating an example set of operations for executing a drawing.

Like reference symbols in the various drawings indicate like elements.

### DETAILED DESCRIPTION

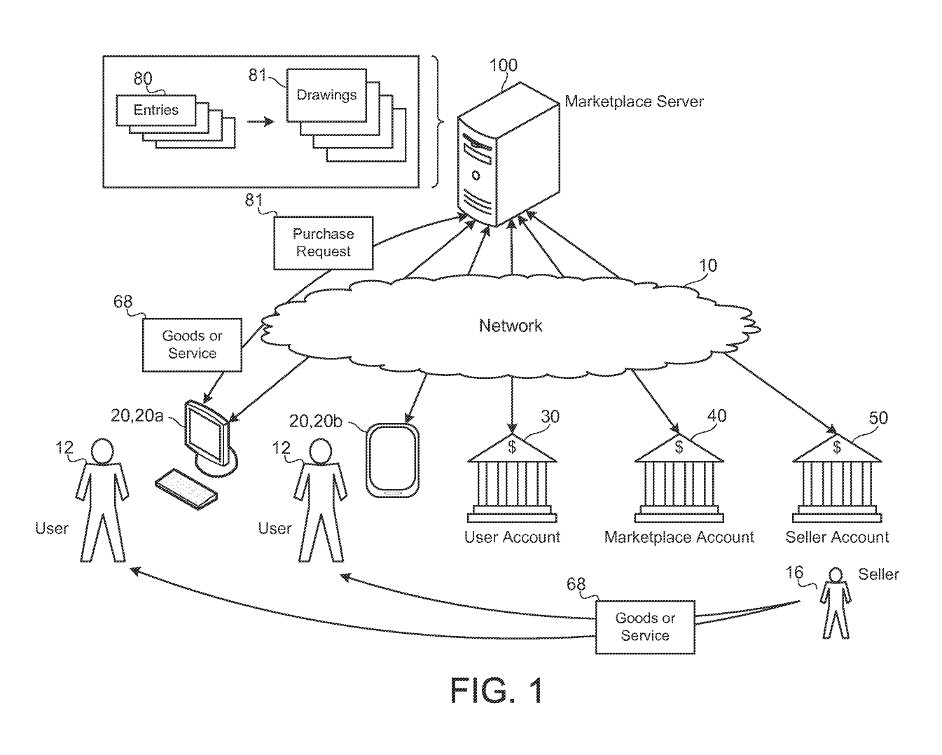

FIG. 1 illustrates an example environment of a marketplace server 100 that is configured to allow users 12 to purchase goods and/or services 68 over a network 10. A user 12 can purchase a good and/or service 68 by providing a purchase request 62 to the marketplace server 100 from a user computing device 20. Upon completing the transaction for the good and/or service 68, the marketplace server 100 awards users 12 with entries 80 to enter one or more drawings 81. The user 12 may have the option of submitting entries to one or more drawings 81 from a plurality of drawings 81, where each drawing 81 may accept a different number of entries 80. The user 12 can select the larger drawings 81 to win larger prizes, albeit at worse odds, or can select smaller drawings 81 to win relatively smaller prizes at higher odds.

A drawing 81 can refer to any game of chance where a plurality of users 12 submit entries 80 to win a prize and one or more of the entries 80 are selected, thereby awarding the prize (or a portion thereof) to the user 12 that entered the selected entry. In some implementations, the prize is a cash prize in an amount that is proportional to the amount of entries 80 that are submitted in the drawing 81. While cash prizes are discussed, the drawing winner may receive non-cash prizes as well. For example, the drawing winner may receive credits to be used to purchase more goods and/or services 68 from the marketplace server 100 and/or free goods or services 68.

The marketplace server 100 may be further configured to, either directly or indirectly, communicate with one or more financial institutions in order to complete purchases and award prizes to drawing winners. For example, the marketplace server 100 may communicate with a first financial institution that maintains a user account 30, a second financial institution that maintains a marketplace account 40, and a third financial institution that maintains a seller account 50. A user account 30 is an account associated with a user 12 of the marketplace server 100. A user 12 can refer to a party that shops and/or purchases goods or services 68 from the marketplace server 100. A marketplace account 40 is an account that is associated with the operator of the marketplace server 100. A seller account can refer to an account that is associated with a seller 16 of a good or service 68. A seller 16 can be any party that offers a good or service 68 for sale on the marketplace server 100. For example, the seller 16 may be a music artist, a music distribution company, a motion picture studio, an artist, a clothing manufacturer, a clothing distributor, a grocer, or any other suitable seller 16. It is noted that that the same financial institution can maintain more than one of the user account 30, the marketplace account 40, and the seller account 50. Furthermore, the term “financial institution” can refer to any financial service that allows a party to store, receive, or transfer funds. The term “financial institution” can refer to, but is not limited to, a bank, a credit card company, and/or a wire transfer service. The term “user computing device” 20 can refer to, for example, a stationary computing device 20a, a mobile computing device 20b, or any other suitable computing device with a user interface.

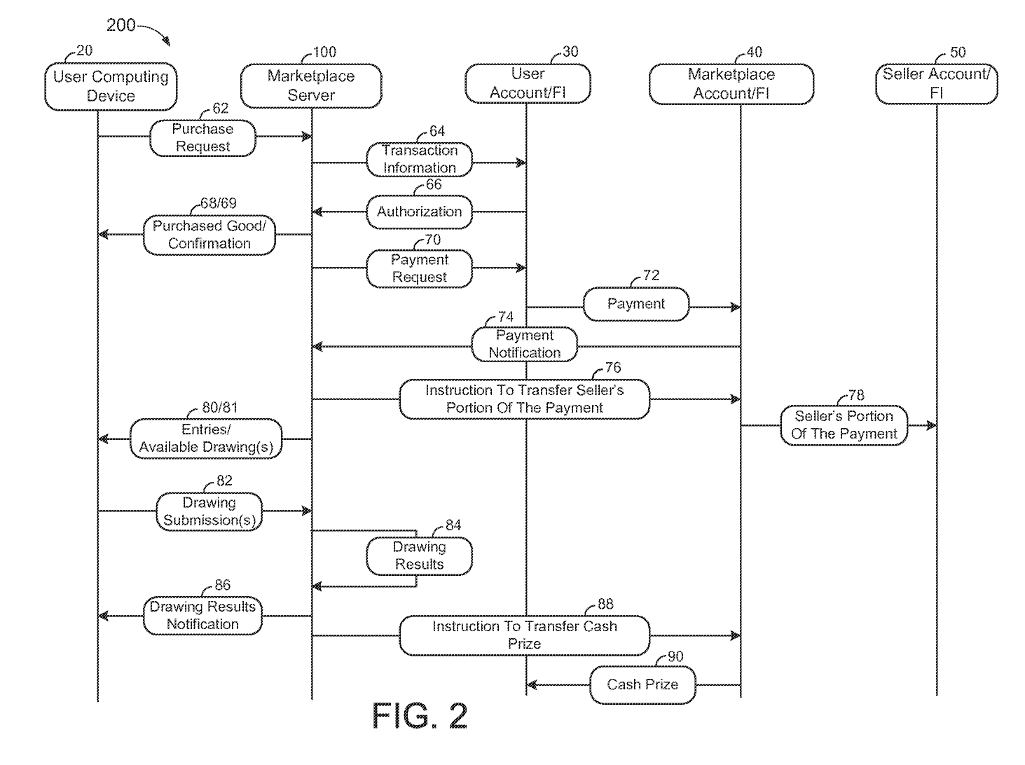

FIG. 2 is a swim lane diagram 200 illustrating an example of a transaction performed using the marketplace server 100. The ordering of operations illustrated in FIG. 2 is provided for example only and is not a required order of operations.

A user 12 may initiate a purchase via a user computing device 20 by submitting a purchase request 62 to the marketplace server 100. The purchase request 62 can identify a good or service that the user 12 wishes to purchase and an amount the user 12 agrees to pay in exchange for the identified good or service 68. The purchase request 62 can further include financial information relating to the transfer of funds, such as a credit card number of the user 12, a bank account and routing number of the user 12, a billing address of the user 12, a zip code of the user 12, a password of the user 12, and/or any other suitable information for processing the transaction. The marketplace server 100 receives the purchase request 62 and provides transaction information 64 contained in the purchase request 62 to the user financial institution (FI). The information contained in the transaction information 64 depends on the type of financial institution, e.g., whether the financial institution is a bank, credit card company, or a money wiring service, and may be obtained from the financial information received in the purchase request. The marketplace server 100 can transmit the transaction information 64 through one or more intermediary parties, such as a payment processing service and/or a gateway service.

The user account financial institution 30 receives the transaction information and can verify the purchase. The user's financial institution 30 can verify the purchase in any suitable manner. If/when the user account financial institution verifies the purchase, the user account financial institution 30 provides an authorization 66 to the marketplace server 100. In response to receiving the authorization 66, the marketplace server 100 can complete the purchase by sending the purchased good 68 and/or a confirmation 69 of the purchase to the user computing device 20. For example, if the user 12 has purchased a digital good, e.g., software, music, television show, book, or movie, the marketplace server 100 can transmit the digital good 68 to the user computing device 20 or allow the user computing device 20 to download the digital good 68. If the user 12 has purchased a tangible good 68, the marketplace server 100 can transmit a confirmation to the user computing device 20 (or an account of the user 12, such as an email account of the user 12) and can initiate the shipping process of the purchased good 68.

The marketplace server 100 sends a payment request 70 to the user account financial institution 30. The payment request 70 can be for the amount agreed upon in the purchase request 62, indicated in the transaction information 64, and authorized by the authorization 66. The marketplace server 100 may provide the payment request 70 to the user account financial institution 30 either directly or through one or more intermediary services. The user account financial institution 30 can then transfer the payment 72 to the marketplace account financial institution 40. In this way, the user account financial institution deposits the payment 72 in the marketplace account 40. The marketplace account financial institution 40 can respond to the marketplace server 100 with a payment notification 74 indicating that the payment has been received. The marketplace server 100 can transmit an instruction 76 to the marketplace account financial institution 40 to transfer a portion of the payment to the seller account financial institution 50. In response to the instruction 76, the marketplace account financial institution 40 transfers the sellers portion 78 of the payment to the seller account financial institution 50.

In response to completing the purchase, the marketplace server 100 can award the user 12 with one or more entries 80. In some implementations, the marketplace server 100 can transmit a web browser of the user computing device 20 or an application executing on the user computing device 20 instructions to display the amount of entries 80 that the user 12 has associated with her or her account. For example, the user 12 may purchase a good 68 which results in the user 12 receiving three (3) entries 80. The marketplace server 100 can also instruct the user computing device 20 to display the available drawings 81. As previously mentioned, the user 12 can select one or more drawings 81 to enter from a plurality of available drawings 81. In response to the instruction to display the available drawings 81, the user computing device 20 displays a graphical user interface (GUI) that allows the user 12 to select which drawings 81 he or she wants to enter. In response to the user 12 selecting which drawings 81 to enter, the user computing device 20 submits one or more drawing selections 82 to the marketplace server 100. The marketplace server 100 can execute a drawing 81 when a drawing condition of the drawing 81 is met. As used herein, executing a drawing 81 can include conducting or facilitating the drawing 81 and/or receiving the drawing results 84. The marketplace server 100 can then transmit a drawing results notification 86 to the user computing device 20 (or an account associated with the user 12). The drawing results notification 86 can indicate the results of a drawing 81 entered by a user 12 (e.g., whether the user 12 won or lost). Assuming that the user 12 has won the drawing, the marketplace server 100 can provide the marketplace account financial institution 40 with an instruction 88 to transfer the prize amount to the user 12. The marketplace account financial institution 40 transfers the cash prize 90 to the user account 30 in response to the instruction 88.

The foregoing is provided for an example transaction conducted by the marketplace server 100. Variations of the transaction are contemplated and are within the scope of the disclosure. For example, the drawing 81 may be for non-cash prizes, such as credits that can be used in connection with the marketplace server 100. Additionally or alternatively, the seller 16 and the operator of the marketplace server 100 may be the same entity or may be in privy to one another.

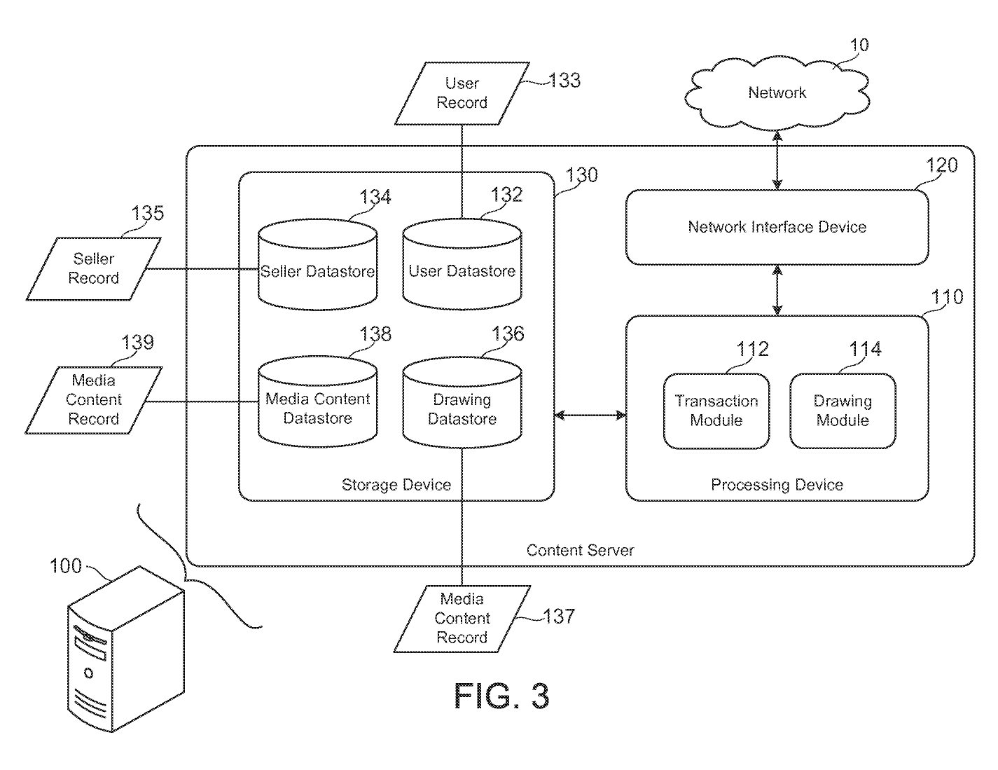

FIG. 3 is a schematic illustrating example components of the marketplace server 100. The marketplace server 100 is configured to facilitate the sale of goods and services 68 and to host or facilitate a plurality of drawings 81. For purposes of explanation only, the marketplace server 100 of FIG. 3 is described as being a media content marketplace server, such that the marketplace server 100 allows users 12 to purchase media content. The marketplace server 100 can include a processing device 110, a storage device 130, and a network interface device 120.

The processing device 110 includes one or more processors and one or more non-transitory computer readable mediums storing machine-readable instructions that are executable by the processors. In implementations including two or more processors, the two or more processors can execute in an individual or distributed manner. The processing device 110 can execute a transaction module 112 and a drawing module 114, both of which may be embodied as machine-readable instructions.

The network interface device 120 performs communication with other remote devices via the network 10. The network interface device 120 can perform wired or wireless communication. Examples of the network interface device 120 include, but are not limited to, a transceiver configured to perform communications using the IEEE 802.11 wireless standard, an Ethernet port, and a universal serial bus (USB) port. While one network interface device 120 is illustrated, the term network interface device 120 can include one or more network interface devices 120.

The storage device 130 can include one or more nonvolatile non-transitory computer readable mediums. Examples of a storages device include, but are not limited to, hard disk drives, solid state drives, optical disk drives, and flash drives. The storage device 130 may store one or more of a user datastore 132, a seller datastore 134, a drawing datastore 136, and a media content datastore 138.

The user datastore 132 stores information of the users 12 of the marketplace server 100. A user record 133 in the in the user datastore 132 may include information specific to the users 12. For example, a user record 133 may include a username, an email address of the user 12, a user account 30 of the user 12, a financial institution of the user 12, a billing address of the user 12, a shipping address of the user 12, and/or a password. Additionally, each user record 133 in the user datastore 132 can identify a purchase history of a user 12, an amount of entries 80 that the user 12 has, any drawings 81 that the user 12 has entered, and/or any entries 80 that the user 12 has won.

The seller datastore 134 stores information regarding the sellers 16. A seller record 135 in the seller datastore 134 may include information specific to a seller 16. For example, a seller record 135 may include a list of goods or services 68 being sold by the seller 16, a price to be paid to the seller 16 for each good or service 68, a seller account 50 of the seller 16 and/or a financial institution of the seller 16. Additionally, each seller record 135 in the seller datastore 134 can identify a history of goods or services 68 sold on behalf of the seller 16.

The drawing datastore 136 stores information regarding each of the drawings 81. A drawing record 137 in the drawing datastore 136 can include information specific to a drawing. For example, a drawing record 137 may include an identifier of the drawing, a status of the drawing 81 (e.g., whether the drawing 81 is complete, still open, or not yet open), a winner of the drawing, a prize amount of the drawing, whether the prize has been delivered, an upper limit of entries 80 for the drawing, a current amount of entries 80 of the drawing, a time when the drawing 81 is closed, the current odds of winning the drawing, and/or any other suitable information. A drawing record 137 in the drawing datastore 136 can be updated, as the marketplace server 100 receives more entries 80 for the drawing 81 and it executes the drawing.

The media content datastore 138 stores information regarding each of the media contents available for purchase. A media content record 139 in the media content datastore 138 can include information specific to a media content. For example, a media content record 139 may include a title of the media content, a format of the media content, an artist of the media content, a publisher of the media content a price of the media content, an amount of entries 80 that the user 12 is awarded for purchasing the media content, a memory location of the media content, and a seller 16 of the media content.

In operation, the transaction module 112 allows users 12 to purchase goods and services 68 via the marketplace server 100. In the example configuration of FIG. 3, the transaction module 112 is configured to allow users 12 to purchase media content, such as digital music files and albums, digital movies, digital television shows, and/or digital books.

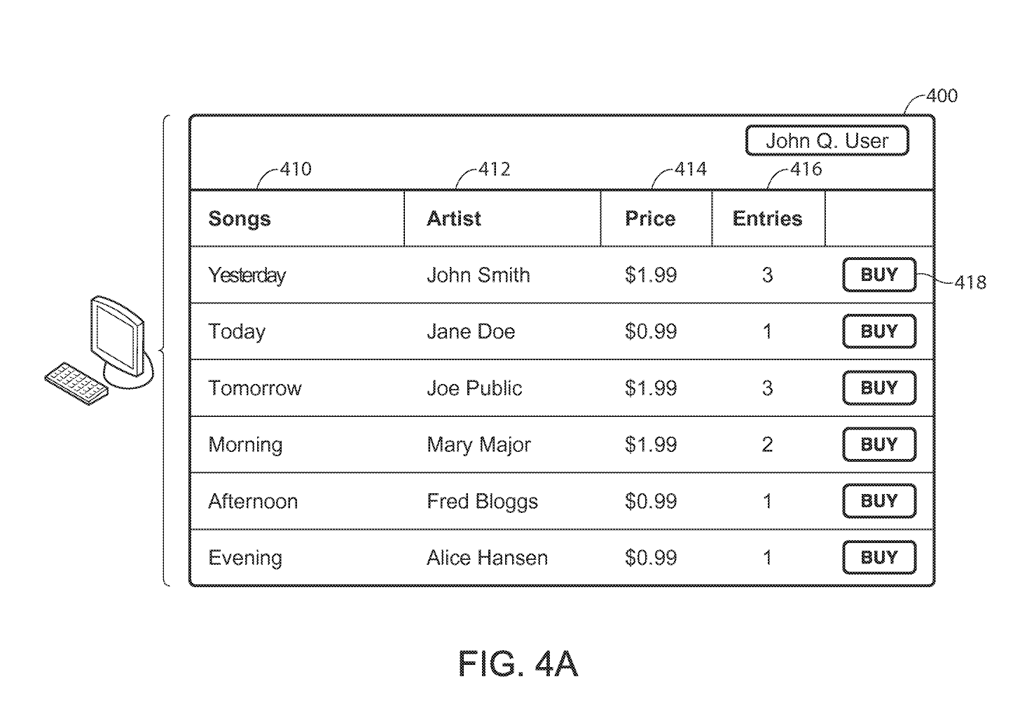

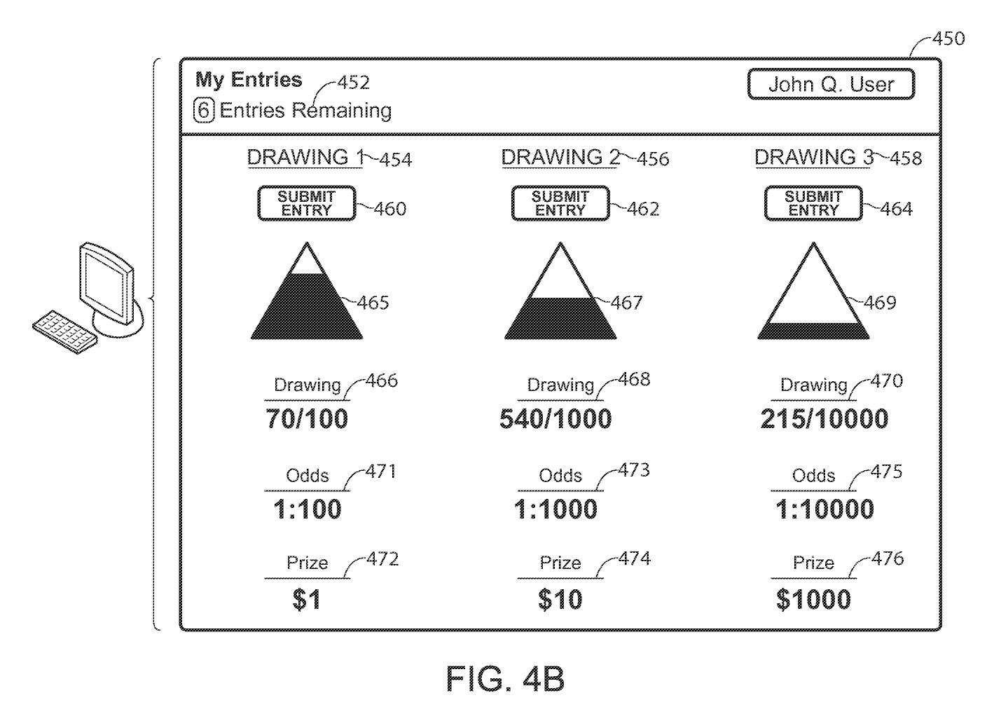

The transaction module 112 may provide instructions to the user computing device 20 for displaying or populating fields in a GUI that is displayed by the user computing device 20. For example, the transaction module 112 can provide JavaScript instructions that contain data for populating one or more fields in the GUI. FIG. 4A illustrates an example GUI 400 that may be displayed by the user computing device 20. A web browser or a dedicated client application executing on the user computing device 20 may display the GUI 400. In the illustrated example, the GUI includes a “songs” field 410, an “artist” field 412, a “price” field 414, and an “entries” field 416. The songs field 410 lists the title of a song. The artist field 412 lists the name of the artist of the song. The price field 414 indicates a price of the song. The entries field 416 lists an amount of entries 80 that the user 12 is awarded for purchasing the song. Each row of the GUI 400 represents a different media content and can include a buy input object 418. A user 12 can purchase a specific media content by clicking on, or otherwise selecting, a corresponding input object 418. In response to such a selection, the user computing device 20 can transmit a purchase request for a selected media content to the marketplace server 100.

In the illustrated example, a user 12 purchasing “Yesterday” by John Smith and receives three (3) entries 80, while a user 12 purchasing “Today” by Jane Doe receives one (1) entry. The foregoing is provided for example only.

The GUI 400 may include additional fields and functionalities without departing from the scope of the disclosure. For example, the GUI 400 may include a search box that allows a user 12 to enter searches for media contents. Additionally or alternatively, the GUI 400 can include a rating field that lists a user 12 rating of each respective media content and/or a popularity field indicating a popularity of each respective media content.

Referring back to FIG. 3, the transaction module 112 receives the purchase request and proceeds to obtain authorization of the purchase. Once authorized, the transaction module 112 can complete the purchase. In the example of FIG. 3, the transaction module 112 can retrieve the purchased media content from memory and can transmit the media content to the user computing device 20 of the user 12. Additionally or alternatively, the transaction module 112 can update the user record 133 of the purchasing user 12 to indicate that the user 12 has digital rights in the purchased media content, such that the user 12 can stream the purchased media content on-demand. In some implementations, the transaction module 112 is further configured to allocate portions of the payment for the purchased media content (or other goods or services 68) to a proper entity or account. For example, the transaction module 112 can allocate a first portion of the funds to a pool for the drawings 81, a second portion of the payment to the seller 16, and a third portion of the payment to the marketplace server 100 operator. For example, if for a media content priced at $1.99 the selling artist (or distribution company) receives $1.09 per purchased copy of the media content, and the purchaser receives three (3) entries 80 worth ten (10) cents apiece, the transaction module 112 can allocate $1.09 to the seller's account 50, thirty (30) cents to the pool for the drawings 81, and sixty (60) cents to the marketplace account.

The drawing module 114 is configured to allow users 12 to enter drawings 81 and to execute drawings 81 when a drawing condition is met. Drawings 81 can be implemented in any suitable manner. In some implementations, drawings 81 can be entry limited drawings 81, such that once a drawing 81 reaches an upper limit of entries 80, the drawing 81 is closed and one or more winners are subsequently selected. In this type of drawing, the drawing condition is whether the amount of entries 80 in a drawing 81 has met the upper limit. Additionally or alternatively, the drawings 81 can be time limited drawings 81, such that at a certain time the drawing 81 is closed and the one or more winners are subsequently selected. In this type of drawing, the drawing condition is whether the current time has reached the time at which the drawing 81 is performed.

The drawing module 114 may provide instructions to the user computing device 20 for displaying or populating fields in a GUI that allows a user 12 to enter one or more drawings 81. For example, the drawing module 114 can provide JavaScript instructions that contain data for populating one or more fields in the GUI. FIG. 4B illustrates an example GUI 450 that may be displayed by the user computing device 20. A web browser or a dedicated client application executing on the user computing device 20 may display the GUI 450. The GUI 450 may be displayed in response to an explicit request of the user to enter the drawings and/or upon the user completing a purchase on the marketplace server 100.

In the illustrated example, the GUI 450 may include an entry field 452 that indicates an amount of entries 80 that the user 12 has remaining. The GUI 450 may also display the available drawings 81. In this example, the user 12 can select from a first drawing 454, a second drawing 456, and a third drawing 458. The GUI 450 also can include one or more input objects that allow the user 12 to select the available drawings 81. In the illustrated example, the user 12 can click on a first input object 460 to submit an entry into the first drawing 454, a second input object 462 to enter the second drawing 456, and a third input object 464 to enter the third drawing 458. When the user 12 selects one of the input objects, the GUI 450 may adjust the value displayed in the entry field 452. Moreover, the web browser or the client application may send an indication of the selection to the marketplace server 100.

The GUI 450 can also display the amount of entries 80 submitted in each drawing 81 and the amount of entries 80 that are accepted for each drawing. In the illustrated example, a first drawing field 466 indicates that the first drawing 454 has seventy (70) entries 80 of a possible one hundred (100) entries 80 and a first visual icon 465 visualizes the ratio of submitted entries 80 to possible entries 80 in the first drawing 454. A second drawing field 468 indicates that the second drawing 456 has five hundred and forty (540) entries 80 of a possible one thousand (1000) entries 80 and a second visual icon 467 visualizes the ratio of submitted entries 80 to possible entries 80 in the second drawing 456. A third drawing field 470 indicates that the third drawing 458 has two hundred and fifteen (215) entries 80 of the possible ten thousand (10000) entries 80 and a third visual icon 469 visualizes the ratio of submitted entries 80 to possible entries 80 in the third drawing 458. The GUI 450 may also display a prize amount for each available drawing. In the illustrated example, the GUI 450 includes a first prize amount 472 indicating that the prize for the first drawing 454 is one (1) dollar, a second prize amount 474 indicating that the prize for the second drawing 456 is ten (10) dollars, and a third prize amount 476 indicating that the prize for the third drawing 458 is one thousand (1000) dollars. The GUI 450 may display additional information as well. In some implementations, the GUI 450 may explicitly display the odds of winning an available drawing. In the illustrated example, the GUI 450 includes first odds 471 indicating that the odds of winning the first drawing 454 are 1:100 per entry, second odds 473 indicating that the odds of winning the second drawing 456 are 1:1000 per entry, and third odds 475 indicating that the odds of winning the third drawing 458 are 1:10000 per entry. Additionally or alternatively, the GUI 450 may display a time when an available drawing closes.

The GUI 450 of FIG. 4B is provided for example only and is not intended to limit the scope of the disclosure. Variations of the GUI 450 are contemplated and are within the scope of the disclosure.

Referring back to FIG. 3, the drawing module 114 receives drawing selections from the user computing device 20 and enters the user 12 in each selected drawing 81. In some implementations, the drawing module 114 updates the drawing record 137 of the selected drawing 81 by adding another entry in the entries 80 of the drawing 81. The drawing module 114 may also increment the number of entries 80 in the drawing 81.

In some implementations, the drawing module 114 allocates an amount corresponding to an entry to a specific drawing 81. For example, if an entry corresponds to ten (10) cents, each time an entry is entered into a specific drawing, the drawing module 114 may allocate ten (10) cents to the specific drawing 81.

When the drawing condition of a particular drawing 81 has been met, the drawing module 114 can execute the drawing 81. In some implementations, the entries 80 in each drawing 81 may be sequentially numbered from one (1) to N, where N is total number of entries 80 in the drawing 81. In these implementations, the drawing module 114 can generate a random number, x, and can determine the winning number according to:

Winning_Entry_Number=x mod N (1)

The drawing module 114 can determine the winner in any other suitable manner. Upon selecting a winning entry, the drawing module 114 can notify the winners that he or she has been selected as the winner of the prize. Further, the drawing module 114 can update the status of the drawing 81 in the corresponding drawing record 137 to indicate that the drawing 81 is complete and to identify the winner. In some implementations, the drawing module 114 initiates the transfer of the prize to the user account 30. In some implementations, the drawing module 114 may replace an executed drawing 81 in the GUI 450 with a new drawing 81 upon execution of the executed drawing 81. In these implementations, the GUI 450 may be updated such that the new drawing 81 is displayed therein upon execution of the executed drawing 81.

The marketplace server 100 of FIG. 3 is provided for example only and not intended to limit the scope of the disclosure. Variations of the marketplace server 100 are contemplated and are within the scope of the disclosure. The marketplace server 100 can be configured to facilitate the sale of other types of goods and services 68. Furthermore, the transaction module 112 and the drawing module 114 may be comprised of one or more submodules.

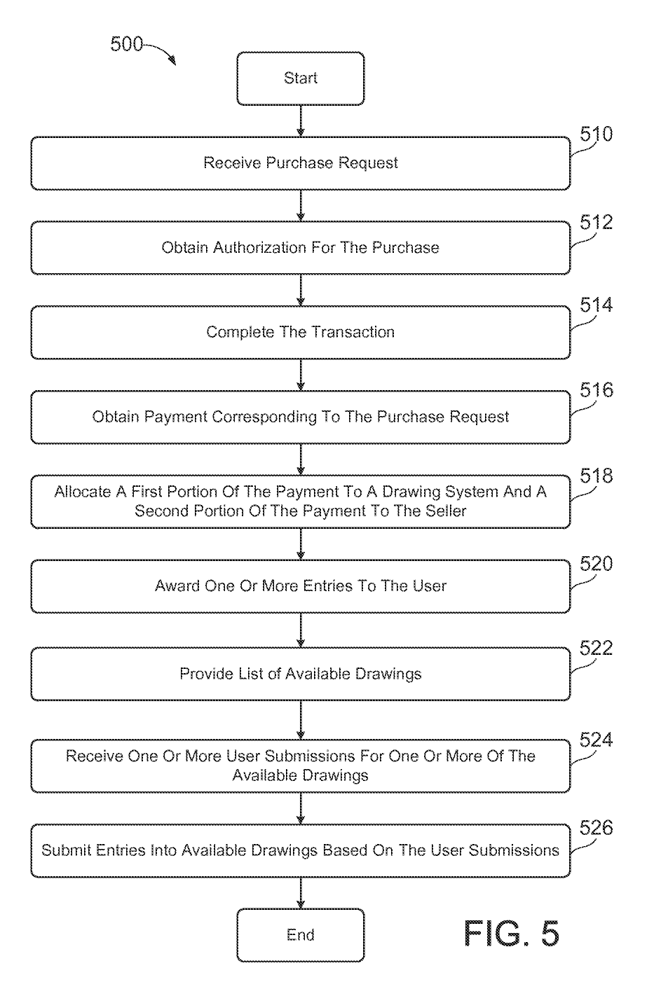

FIG. 5 illustrates an example set of operations 500 for performing a method for facilitating a transaction. For purposes of explanation, the method is explained as being described by the components of the marketplace server 100 of FIGS. 1 and 3. Any other suitable device may, however, execute the method.

At operation 510, the transaction module 112 receives a purchase request from a user computing device. As previously discussed, the purchase request can identify a good or service 68 to be purchased, a payment amount for the good or service 68, and financial information of the purchasing user 12.

At operation 512, the transaction module 112 obtains authorization for the purchase. The transaction module 112 can obtain the financial information of the user 12 from the purchase request, which it transmits to a financial institution 30 of the user 12 (either directly or indirectly). The financial institution 30 of the user 12 can verify the financial information and the payment amount and can authorize the payment amount to be paid to the marketplace server 100. The user's financial institution 30 can transmit the authorization to the marketplace server 100 (either directly or indirectly).

At operation 514, the transaction module 112 completes the transaction. The manner by which the transaction module 112 completes the transaction varies on the good or service 68 being sold. For instance, if a tangible good 68 is sold, the transaction module 112 can transmit a purchase order to a warehouse or sender, obtain shipping information for sending the good or service 68, and transmit a confirmation email to an account of the user 12 indicating the completed purchase and the shipping information. If the good 68 is a digital good 68, the transaction module 112 can transmit the digital good 68 to the user computing device 20, make the digital good 68 available for download, and/or make the digital good 68 available for streaming.

At operation 516, the transaction module 112 obtains the payment for the purchased good or service 68 from the user account 30. In some implementations, the transaction module 112 transmits a payment request (either directly or indirectly) to the financial institution that maintains the user account 30. Having previously authorized the payment, the financial institution can transfer the payment amount from the user account 30 to the marketplace account 40 associated with the marketplace server 100.

At operation 518, the drawing module 114 allocates a first portion of the payment to the drawing system and a second portion of the payment to the seller 16. The amount of the first portion of the payment may depend on how many entries 80 are awarded to the user 12 in exchange for the purchase and the monetary value associated with each entry. The transaction module 112 may allocate the first portion of the payment to a general money buffer. The general money buffer accounts for any funds that have not been allocated to a specific drawing. Thus, the amount of funds in the general money buffer may be equal to the product of the number of unused entries 80 and the monetary value of an entry. As users 12 submit entries 80, the funds corresponding to a particular entry are allocated to the selected entry.

The transaction module 112 may allocate the second portion of the payment to the seller 16 by initiating a transfer of funds from the marketplace account 40 to the seller account 50. In some implementations, the transaction module 112 determines the amount to allocate to the seller 16 from the seller record 135 of the seller 16. The seller record 135 may indicate the agreed upon price for the purchased good or service 68 and the seller's financial information, e.g., a bank account number or other identifier of the seller account 50. The transaction module 112 uses this information to transfer the agreed upon price to the seller account 50.

At operation 520, the drawing module 114 awards one or more entries 80 to the user 12 based on the purchased good or service 68. The drawing module 114 can update the amount of unused entries 80 in the user record 133 of the user 12. The drawing module 114 may also transmit an instruction to the GUI 450 executing on the user computing device 20 to increment the value displayed in the “remaining entries” by the amount of awarded entries 80.

At operation 522, the drawing module 114 provides a list of available drawings 81 to the user computing device 20. In some implementations, the drawing module 114 searches the drawing datastore 136 for any drawings 81 that are currently active. For each currently active drawing, the drawing module 114 can retrieve its corresponding drawing record 137 and determine the information pertaining to the drawing, e.g., type of drawing, how many entries 80 are currently entered, how many entries 80 can be entered, the time at which the drawing 81 closes, and the current odds of winning the drawing. The drawing module 114 can generate instructions for populating the GUI 450 with the information pertaining to the available drawings 81 and can transmit the instructions to the user computing device 20.

At operation 524, the drawing module 114 receives one or more user submissions for one or more of the available drawings 81. A user submission can indicate that the user 12 has selected to submit one entry in a specified available drawing. The user submission may be initiated by the user via the GUI 450.

At operation 526, the drawing module 114 submits an entry into each available drawing 81 indicated by the user submissions. For each entry, the drawing module 114 can update the drawing record 137 thereof to indicate that another entry has been submitted into the available drawing. The drawing module 114 may also update the odds of winning the drawing 81 in the drawing record 137 if the drawing 81 is not limited to a predetermined number of drawings 81. In some implementations, the drawing module 114 may also allocate an amount of funds corresponding to an entry from the general money buffer to a buffer of a selected drawing. For each entry submitted on behalf of the user 12, the drawing module 114 can also decrement the number of remaining entries 80 in the user record 133 of the user 12.

The method of FIG. 5 is provided for example only and not intended to limit the scope of the disclosure. Variations of the method are contemplated and are within the scope of the disclosure.

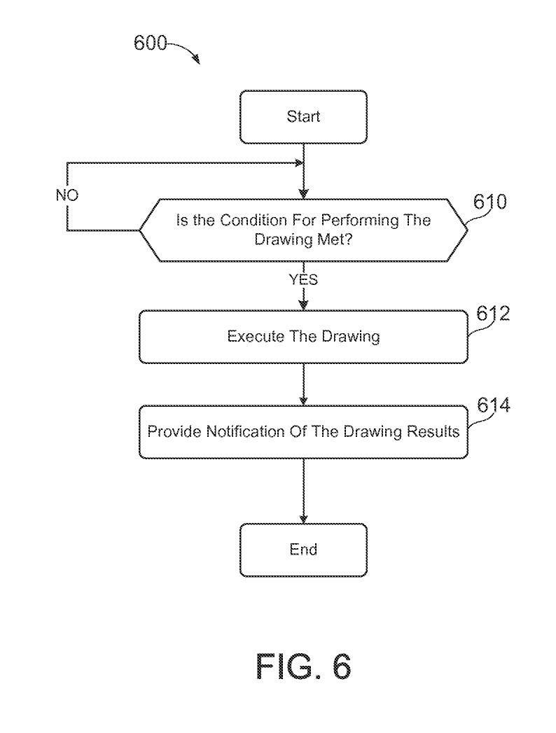

FIG. 6 illustrates an example set of operations 600 of a method for executing a drawing 81 is illustrated. The method is explained as being executed by the marketplace server 100. Any suitable computing device, however, may execute the method. Furthermore, the method is explained with respect to one available drawing. The marketplace server 100 may execute the method concurrently with respect to each available drawing.

At operation 610, the drawing module 114 monitors an available drawing 81 to determine whether a condition for performing the drawing 81 has been met. As discussed, a drawing 81 may be closed at a specific time or when the amount of entries 80 reaches an upper limit. Thus, if an available drawing 81 is a time limited drawing, the drawing module 114 can compare the current time with the closing time of the available drawing. If the current time has reached the closing time, then the available drawing 81 is closed and the drawing module 114 cannot receive any new entries 80 to the closed drawing. If an available drawing 81 is an entry limited drawing, the drawing module 114 can check whether the number of entries 80 entered in the available drawing 81 has reached the upper limit of the available drawing 81 each time a new entry is entered into the available drawing. If so, the drawing module 114 can close the available drawing 81 and the drawing module 114 cannot receive any new entries 80 to the closed drawing. If the drawing condition is not met, the drawing module 114 can continue to monitor the available drawing.

At operation 612, the drawing module 114 executes the drawing. The drawing module 114 may execute the drawing 81 in any suitable manner. In some implementations, the drawing module 114 generates a random number. The drawing module 114 selects the winning entry based on the random number. In some implementations, the drawing module 114 determines a winning entry using equation (1), as discussed above. It is noted that the drawing module 114 may also select a second place winner, and even a third place winner.

At operation 614, the drawing module 114 provides notification of the drawing 81 results. In some implementations, the drawing module 114 sends a notification to the winner or winners of the drawing. The drawing module 114 can send the notification, for example, to an email account of the user 12. Additionally or alternatively, the notification may be provided to the user 12 upon the user logging onto the marketplace server 100. In some implementations, the drawing module 114 may send notifications to all of the entrants in the drawing, not just the winning entrants.

The method of FIG. 6 is provided for example only and not intended to limit the scope of the disclosure. Variations of the method are contemplated and are within the scope of the disclosure. For example, drawings 81 may execute continuously in real-time or at specific intervals (e.g., once an hour, day, week, month, etc.).

Various implementations of the systems and techniques described here can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Moreover, subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The terms “data processing apparatus”, “computing device” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as an application, program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

One or more aspects of the disclosure can be implemented in a computing system that includes a backend component, e.g., as a data server, or that includes a middleware component, e.g., an application server, or that includes a frontend component, e.g., a client computer having a graphical user interface or a Web browser through which a user can interact with an implementation of the subject matter described in this specification, or any combination of one or more such backend, middleware, or frontend components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specifics, these should not be construed as limitations on the scope of the disclosure or of what may be claimed, but rather as descriptions of features specific to particular implementations of the disclosure. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

What is claimed is:

1. A method comprising:
receiving, at a processing device, a purchase request of a user, the purchase request indicating a good or service to be purchased by the user;
receiving, at the processing device, a payment corresponding to the purchase request from an account associated with the user;
allocating, at the processing device, a first portion of the payment to a drawing system being comprised of a plurality of available drawings;
awarding, at the processing device, one or more entries to a user, wherein the user can enter each entry into one of a plurality of available drawings, each available drawing being for a respective prize and having its own respective odds;
receiving, at the processing device, one or more user submissions, each user submission indicating a selection of one of the plurality of available drawings in which one of the one or more entries is to be entered; and
for each user submission, entering, at the processing device, one of the entries of the user into a selected available drawing indicated in the user submission.

2. The method of claim 1, further comprising allocating, at the processing device, a second portion of the payment to a seller of the good or service.

3. The method of claim 1, wherein the purchase request is for one or more digital media files.

4. The method of claim 1, further comprising providing, from the processing device, instructions corresponding to a graphical user interface to a remote computing device, the instructions being configured to cause the graphical user interface to display the plurality of available drawings and receive the one or more user submissions.

5. The method of claim 4, wherein the instructions are further configured to cause the graphical user interface to display odds of winning each available drawing.

6. The method of claim 4, wherein the instructions are further configured to cause the graphical user interface to display, for each available drawing, a first amount of entries that have already been entered in the available drawing and a second amount of entries that are to be entered in the available drawing before a winner of the available drawing is selected.

7. The method of claim 1, wherein each available drawing has a corresponding upper limit of entries, wherein the upper limit of a respective available drawing defines a total amount of entries that can be entered in the respective available drawing before a winner of the respective available drawing is selected.

8. The method of claim 1, wherein the purchase request is received from a remote computing device associated with the user.

9. The method of claim 1, wherein the prize is a cash prize in an amount that is independent of the other available drawings.

10. A server comprising:
a non-transitory storage device;
a network interface device; and
a processing device executing a transaction module and a drawing module;
wherein the transaction module is configured to:
receive a purchase request of a user, the purchase request indicating a good or service to be purchased by the user;
receive a payment corresponding to the purchase request from an account associated with the user; and
allocate a first portion of the payment to a drawing system being comprised of a plurality of available drawings; and
wherein the drawing module is configured to:
award one or more entries to the user, wherein the user can enter each entry into one of a plurality of available drawings, each available drawing being for a respective prize and having its own respective odds;
receive one or more user submissions, each user submission indicating a selection of one of the plurality of available drawings in which one of the one or more entries is to be entered; and
for each user submission, enter one of the entries of the user into a selected available drawing indicated in the user submission.

11. The server of claim 10, wherein the transaction module is further configured to allocate a second portion of the payment to a seller of the good or service.

12. The server of claim 10, wherein the purchase request is for one or more digital media files.

13. The server of claim 10, wherein the drawing module is further configured to provide instructions corresponding to a graphical user interface to a remote computing device, the instructions being configured to cause the graphical user interface to display the plurality of available drawings and receive the one or more user submissions.

14. The server of claim 13, wherein the instructions are further configured to cause the graphical user interface to display odds of winning each available drawing.

15. The server of claim 13, wherein the instructions are further configured to cause the graphical user interface to display, for each available drawing, a first amount of entries that have already been entered in the available drawing and a second amount of entries that are to be entered in the available drawing before a winner of the available drawing is selected.

16. The server of claim 13, wherein each available drawing has a corresponding upper limit of entries, wherein the upper limit of a respective available drawing defines a total amount of entries that can be entered in the respective available drawing before a winner of the respective available drawing is selected.

17. The server of claim 10, wherein the purchase request is received from a remote computing device associated with the user.

18. The server of claim 13, wherein the prize is a cash prize in an amount that is independent of the other available drawings.

19. A method comprising:
receiving, at a processing device, a purchase request for a remote computing device of a user, the purchase request indicating a digital media content to be purchased by the user;
receiving, at the processing device, authorization to charge the user an amount of indicated in the purchase request from a financial institution associated with the user;
providing, at the processing device, access to the digital media content to the user in response to the authorization;
receiving, at the processing device, a payment in the amount authorized by the financial institution from an account of the user at the financial institution;
allocating, at the processing device, a first portion of the payment to a drawing system being comprised of a plurality of available drawings;
allocating, at the processing device, a second portion of the payment to a provider of the digital media content;
awarding, at the processing device, one or more entries to a user based on a value of the first portion, wherein the user can enter each entry into one of a plurality of available drawings, each available drawing being for a cash prize and having its own respective odds;
receiving, at the processing device, one or more user submissions, each user submission indicating a selection of one of the plurality of available drawings in which one of the one or more entries is to be entered;
for each user submission, entering, at the processing device, one of the entries of the user into a selected available drawing indicated in the user submission; and
for each available drawing:
determining, at the processing device, whether a drawing condition of the available drawing has been met; and
when the drawing condition has been met, determining a winner of the available drawing.

20. The method of claim 19, further comprising providing, from the processing device, instructions corresponding to a graphical user interface to a remote computing device, wherein the instructions are configured to cause the graphical user interface to display the plurality of available drawings, odds of winning each available drawing, a first amount of entries that have already been entered in the available drawing, and a second amount of entries that are to be entered in the available drawing before a winner of the available drawing is selected, and wherein the instructions are further configured to cause the graphical user interface to receive the user submissions.
